(19) United States
(12) Patent Application Publication
(10) Pub. No.: US 2026/0004670 A1
(43) Pub. Date: Jan. 1, 2026

(54) APPARATUSES, SYSTEMS AND METHODS FOR USING ARTIFICIAL INTELLIGENT ASSISTANTS TO AID IN VEHICLE ASSESSMENT

(71) Applicants: Max Bordakh, Draper, UT (US); Alexander Bordakh, Midvale, UT (US)

(72) Inventors: Max Bordakh, Draper, UT (US); Alexander Bordakh, Midvale, UT (US)

(21) Appl. No.: 19/204,464

(22) Filed: May 9, 2025

Related U.S. Application Data
(60) Provisional application No. 63/644,519, filed on May 9, 2024.

(51) Int. Cl. G09B 5/02; G06F 16/3329; G06Q 30/018; G06Q 30/0601

(52) U.S. Cl. CPC G09B 5/02; G06F 16/3329; G06Q 30/0185; G06Q 30/0631

(57) ABSTRACT

An artificial intelligence-based system and method facilitate enhanced interaction between users and mechanical devices such as vehicles. One system uses an application equipped with AI algorithms to process user inputs concerning specific vehicle information and issues, providing tailored recommendations and feedback. This includes automated troubleshooting, parts recommendations, and maintenance advice, aiming to improve user experience and vehicle upkeep efficiency.

### CROSS-REFERENCES TO RELATED PATENT APPLICATIONS

This application claims benefit under U.S. Provisional Patent Application No. 63/644,519, filed on May 9, 2024, which is hereby specifically incorporated by reference in its entirety into the present disclosure.

### STATEMENT REGARDING FEDERALLY SPONSORED RESEARCH OR DEVELOPMENT

### Not Applicable.

### REFERENCE TO SEQUENCE LISTING, A TABLE, OR A COMPUTER PROGRAM LISTING COMPACT DISK APPENDIX

Not Applicable.

### BACKGROUND

The field of the inventive subject matter relates to motorized vehicle assistance using artificial intelligence. Many embodiments include an artificial intelligent (AI) driven assistant for aiding in control and feedback of motorized vehicles, aircraft, and watercraft.

### SUMMARY

The illustrative embodiments provide computer-implemented methods, apparatuses, and systems for allowing users of mechanical based devices so that they can interact with those devices using app based downloadable software having artificial intelligence algorithms leading to more efficient features and a better user experience.

Many of the embodiments include methods, systems, and apparatuses designed to improve the interaction between users and vehicles (including cars, aircraft, and watercraft) through AI-driven assistance. This assistance can be delivered via an application (or app) or a non-downloadable service with embedded AI algorithms that enhance user experience through efficient and customized interactions. Features include vehicle-specific troubleshooting, parts recommendations, and maintenance tips based on user inputs, which may include vehicle make, model, year, and condition-specific questions.

In one example, a computer-implemented method is provided for assisting users in vehicle maintenance, including the steps of: receiving a user input specifying a vehicle's make, model, year, and a maintenance issue; processing the user input through an artificial intelligence engine; generating vehicle-specific maintenance advice based on the processed input; and displaying the advice to the user through a user interface. Another example further has maintenance advice including step-by-step troubleshooting guidance.

Another example further includes the step of linking to an online store for purchasing recommended parts. Another example further includes a feature to suggest vehicle upgrades or modifications based on the analysis of repeated issues or queries.

Another example extends the user input to include non-standard vehicle parameters like engine type or drive train type and another example further includes the ability of dynamically adjusting the verbosity or technicality of the advice based on a detected user expertise level.

Another example further includes the step of storing a history of user interactions and generating predictive prompts based on prior inputs. Another example further includes the step of the AI engine being trained using datasets derived from repair manuals, mechanic forums, and parts catalogs. Yet another example further includes the step of identifying incompatible or counterfeit parts and alerting the user. Another example further includes a gamified feedback mechanism awarding users based on successful task completion.

An example of a system for vehicle assistance includes a user interface configured to receive data inputs related to vehicle specifications and user queries; an artificial intelligence engine programmed to analyze the data inputs and identify relevant vehicle issues; a database storing user-specific vehicle data and associated queries; and a communication module to present solutions and parts recommendations based on the engine's analysis.

Another example of the system includes an artificial intelligence engine that updates its responses based on feedback received from users regarding the accuracy of the advice and recommendations.

Another example of the system wherein the user interface includes a graphical slider allowing users to specify their skill level, which adjusts the complexity of the information presented. Another example of the system further includes a feature to save historical user queries to streamline future interactions. Another example of the system further has the capability to be integrated with one or more external databases to enhance the accuracy of parts and services recommendations. Another example includes an onboard diagnostic port interface for retrieving real-time vehicle telemetry and using it in an analysis. Another example includes the storage of the user interaction data for verification of repair attempts and any repair results in a decentralized ledger. Another example of the system further includes a module for overlaying repair instructions using augmented reality (AR) glasses. Another example of the system uses an artificial intelligence engine that includes a large language model fine-tuned with mechanical service data. Another example of the system further includes a mechanic network interface enabling live support from certified mechanics based on AI triage.

### DETAILED DESCRIPTION OF THE DRAWINGS

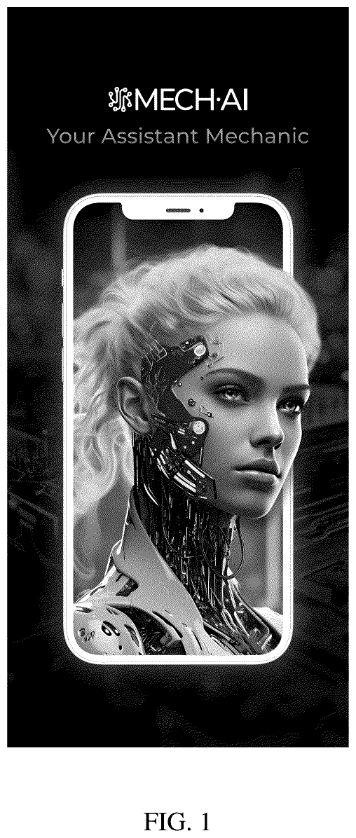

FIG. 1 illustrates an exemplary initial screen shot used with an end user facing application according to embodiments of the inventive subject matter;

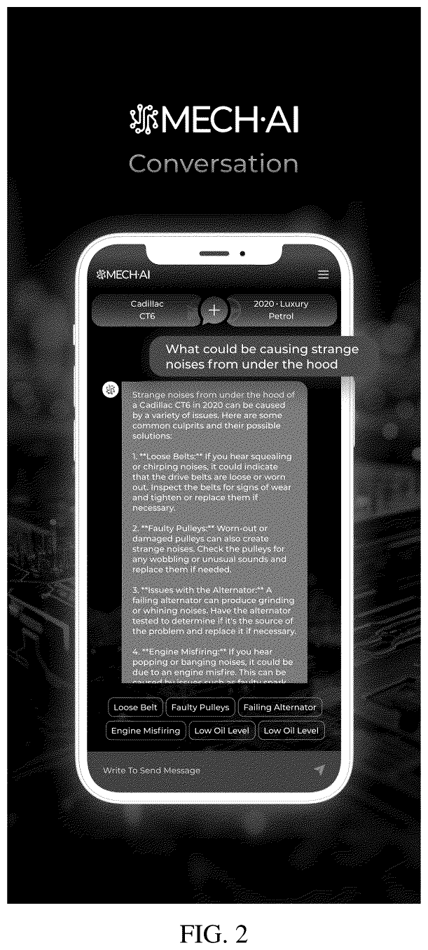

FIG. 2 shows an exemplary vehicle problem diagnosis question and answer screen according to embodiments of the inventive subject matter;

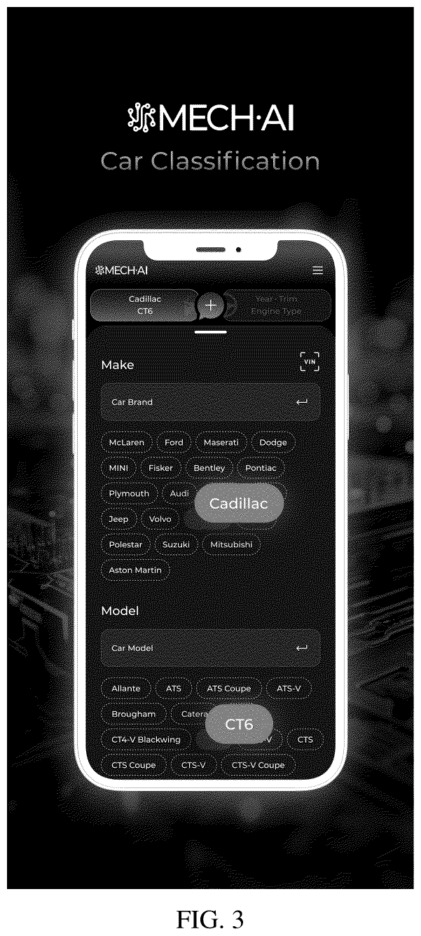

FIG. 3 shows an exemplary vehicle selection screen according to embodiments of the inventive subject matter;

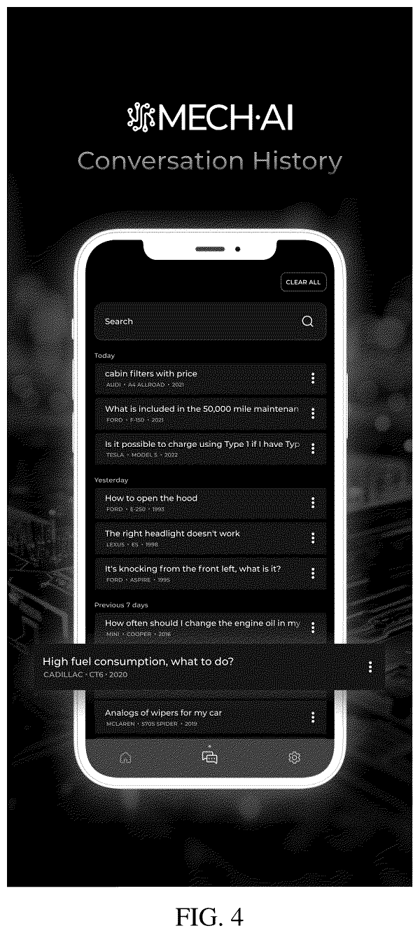

FIG. 4 illustrates an exemplary conversation history screen according to embodiments of the inventive subject matter;

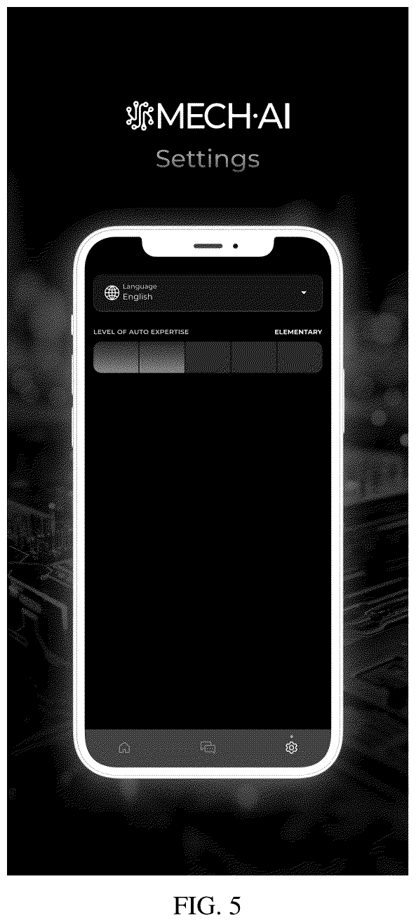

FIG. 5 illustrates an exemplary graphic slider according to embodiments of the inventive subject matter; and

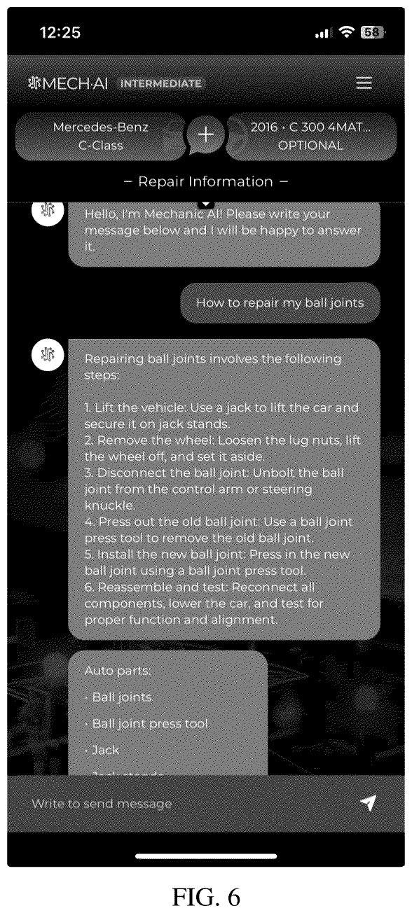

FIG. 6 illustrates an exemplary conversation including recommended steps and parts recommendations according to embodiments of the inventive subject matter.

### DETAILED DESCRIPTION OF THE EMBODIMENTS

According to embodiments of the inventive subject matter, various apparatuses, systems, and methods systems for AI-Driven assistance that uses an artificial intelligence (AI) implemented engine that can understand and respond to user queries related to motorized vehicles, aircraft, and watercraft.

As used herein, including in the claims, the term “and/or,” used in connection with a list of items or categories, means one or more of the items or categories in the list, i.e., at least one of the items or categories in the list, but not necessarily all the items in the list and not necessarily one item from each category in the list. As used herein, including in the claims, the term “or,” used in connection with a list of items or categories, means one or more of the items or categories in the list, i.e., at least one of the items or categories in the list, but not necessarily all the items in the list and not necessarily one item from each category in the list. “Or” does not mean “exclusive or,” and “or” does not mean “at least one from each (category).”

In many embodiments of the systems and methods, a user can input a vehicle specification (e.g. make, model, year, and trim of a vehicle such as a car, watercraft or aircraft) along with additional information relating to a question or an issue associated with the vehicle specification. For example, a car could be entered with the following information: year 2014, mark Toyota, model Tundra, and trim SR5, along with a query “my front head light is out, how do I fix it?” The system can provide feedback to this input with text, audio, video or any combination of the aforementioned manners. In this example, the response could be “to fix a front headlight that is out on a 2014 Toyota Tundra, you can follow these five steps:
1. **Check the Bulb**: The first thing to do is check the headlight bulb. It may be burnt out and need replacement. Consult your owner's manual for the correct bulb type.
2. **Inspect the Wiring**: Check the wiring connected to the headlight bulb for any visible damage or loose connections. Make sure the wiring harness is securely attached.
3. **Check the Fuse**: The headlight circuit may have a blown fuse. Locate the fuse box, usually under the dashboard or in the engine bay, and check the headlight fuse. Replace if necessary.
4. **Test the Headlight Switch**: The issue could also be with the headlight switch. Test the switch to ensure it is sending power to the headlight circuit. If the switch is faulty, it will need to be replaced.
5. **Inspect the Headlight Assembly**: If all the above steps check out but the headlight still doesn't work, there may be a problem with the headlight assembly itself. In this case, the assembly may need to be replaced.

Turning now to the figures, FIG. 1 illustrates an exemplary initial screen shot used with an end user facing application according to embodiments of the inventive subject matter and FIG. 2 shows an exemplary vehicle problem diagnosis question and answer screen according to embodiments of the inventive subject matter.

Many of the embodiments include a search settings feature. Using this feature, users of these embodiments can identify their specific vehicle type, inputting accurate prompts that enable the AI engine to generate highly relevant and customized results.

For example, the user can input a vehicle type and the user would then be guided through series of prompts in the following order:
1. Year
2. Make
3. Model
4. Trim

In other examples, additional information may be prompted including engine type, drive train type and information about the vehicle's enablement of EV, Conventional or Hybrid specifications.

In many of these embodiments, once the user enters the information for a vehicle along with entering one or more questions about the vehicle, the information is saved and associated with the user in a database so that the user will not need to enter this same information again for the purposes of asking additional questions at any time in the future. Additional questions may also be input into the embodiments which would then provide feedback on all or some of the combination of questions previously used as input.

In some of the embodiments, one or more discussions can be initiated using the previous information input by the user relating to the vehicle or to another vehicle.

Some embodiments include an expert level interface wherein the embodiments recognize the skill level of the user based on one or more models as not all users have the same level of expertise. These embodiments can also allow a user to specify their skill level and then tailor the feedback to the user to match their proficiency and knowledge thereby ensuring that both beginners and experts receive the feedback such as assistance and support that is needed for their specific situation.

The embodiments can also analyze a user's input and set a specific skill level for that specific user. The embodiments can also change the skill level for a user anytime. For example, once a user starts entering information, the embodiment can recognize a higher or lower skill level from the input provided by the user and make adjustments to the skill level setting so that the appropriate skill level of feedback is provided.

In many of the embodiments, a user will have the option to use a slider graphic interface to select their level of expertise, for example in the field of auto repair. In one example, based on the slider graphic interface selection, the response from the embodiment will be formed in a way that can be best understood by the user at their particular skill level such as one or more additional breakdowns of the relevant information may be included for answers provided to users of a low or lower expertise compared to a high or higher skilled user. FIG. 4 illustrates an exemplary graphic slider that is used with embodiments.

Many of the embodiments can provide information about specific vehicles along with one or more part recommendations based on the identified issue and specific vehicle.

FIG. 3 illustrates an exemplary vehicle selection screen according to many embodiments. These embodiments can provide information about recommended maintenance or repairs based on the same or different input from the user. FIG. 4 illustrates an exemplary conversation history screen according to many of the embodiments. More than one user may also enter their own information leading to feedback provided to one or both users. FIG. 5 illustrates an exemplary graphic slider allowing the user to set his or her expertise level.

As previously described, many of the embodiments include the ability of the embodiments to make one or more vehicle part suggestions to the user based on their vehicle type selected and the mechanical issue they're having with the vehicle. For example, if a problem with a specific automobile is determined to be a faulty spark plug, both a spark plug wire and a spark plug may be recommended by the embodiment. The parts that are recommended can be linked online to a provider leading to a sale with a commission or an affiliate fee for the click or user's purchase of one or more parts from a part distributor/dealer or a service from a service provider. Thus, the embodiments can help simplify the vehicle repair process both for the user and the support staff servicing the vehicle.

FIG. 6 illustrates an exemplary conversation including recommended steps and parts recommendations according to many of the embodiments. In many of the embodiments used online with the internet, integration with one or more online stores can direct users to one or more reputable platforms or parts and/or service listings wherein the user can review the appropriate information and cost and then decide to make one or more purchases based on the recommended parts and/or services.

In some embodiments, a part (or service) can be located for the user in a separate step. For example, the user can be presented with an option to select a national retailer partner for auto parts. This step can include an online search result on a retailer's online e-commerce marketplace so that the user is directed to the specific website page for the appropriate part selection allowing the user to bypass the marketplace's standard vehicle Make/Model/Year/Trim required data entry before the user would be directed to the relevant website page.

In additional embodiments, the artificial intelligence (AI) engine may be implemented as a machine learning (ML) or natural language processing (NLP) model trained on a one or more of a group of vehicle repair manuals, mechanic support forums, warranty databases, and service records. The AI engine may include a diagnostic layer that maps symptoms described in natural language to mechanical systems, known failure modes, and verified repair procedures.

The user interface (UI) may be implemented as a mobile app, in-vehicle infotainment software, or browser-based interface. In some embodiments, the UI supports voice input and output, enabling hands-free operation. The UI may include dropdown menus, graphical sliders for skill level, toggles for vehicle type (e.g., gasoline, electric, hybrid), and contextual menus based on prior user queries.

In many embodiments, users are prompted to input or confirm vehicle parameters such as year, make, model, trim, engine type, drivetrain, mileage, and history of issues. This information may be stored securely and used to create a persistent profile associated with the user or their account. User profiles may be stored in a centralized or decentralized (for example a blockchain based) database and may be used to predict maintenance needs or compare performance with similar vehicle cohorts.

In some embodiments, the AI system is connected to an OBD-II interface that allows the application to collect real-time vehicle telemetry, including error codes, sensor data, and performance metrics. This data may be cross-referenced with the AI engine's knowledge base to confirm or refine diagnoses. The system may provide visual and auditory walkthroughs for resolving identified issues, including 3D animations or augmented reality overlays for step-by-step repairs.

Certain embodiments include an escalation path for complex diagnoses, allowing users to connect directly with certified mechanics via text, video, or remote diagnostic interface. In fleet-based versions of the system, administrators can monitor multiple vehicles, track repairs, and receive alerts when predictive maintenance thresholds are met.

To ensure adaptability, some systems dynamically adjust the complexity of responses based on user feedback or observed interaction patterns. For example, a novice user may receive simplified instructions and visual aids, while an advanced user may receive concise text-based guidance.

In some embodiments, the system includes an AI triage module that is configured to evaluate the severity or complexity of a user's reported issue and determine whether escalation to a human expert is advisable. The triage process may involve analyzing patterns in user input, historical problem resolution data, or diagnostic codes obtained from onboard systems. Based on this evaluation, the system can route the user to a certified mechanic for remote consultation or in-person service.

The mechanic network interface may be implemented as a secure communications bridge between the AI assistant and a verified mechanic database. This module can identify available mechanics based on the user's location, issue category, and urgency level. The system can then facilitate live video support, real-time messaging, or appointment scheduling for repairs requiring human intervention.

The artificial intelligence engine in some embodiments may be implemented as a large language model (LLM) that has been fine-tuned using domain-specific corpora including service bulletins, parts catalogs, instructional guides, vehicle schematics, and anonymized service records. The LLM architecture allows the system to interpret natural language queries, provide contextual recommendations, and disambiguate vague user inputs by inferring likely meanings based on historical usage patterns.

In other embodiments, the system may incorporate an augmented reality (AR) overlay module. This feature can use a mobile device's camera or connected smart glasses to visually guide the user through the repair process. Key repair components may be highlighted on the user's screen, and interactive instructions can be displayed step-by-step based on the AI's assessment of the issue.

To ensure integrity and traceability, certain embodiments utilize a decentralized ledger, such as a blockchain-based system, to store user interaction histories, repair actions taken, and service confirmations. This data can be used to verify that a repair was properly completed and may be accessed by third parties, such as future vehicle buyers, insurance providers, or fleet operators.

In some embodiments, the system provides gamified feedback mechanisms wherein users earn points, badges, or rewards upon successful completion of recommended repair steps. Feedback from users about the accuracy and helpfulness of recommendations can be used to refine the AI's decision matrix, enabling continuous improvement in output quality.

While the present application discusses embodiments for providing vehicle parts and service recommendations, the embodiments discussed herein may be used in conjunction with other digital assets and products or services as well. Parts and services recommendation systems and methods discussed herein, may be implemented for any type of digital asset, for example using smart contracts on a blockchain for parts and/or services. Other embodiments of the present inventive subject matter may also be used in conjunction with other services such as financial services such as appraisals of digital assets and/or auctions as benchmarks for valuing vehicles based on the condition of the vehicle using the feedback from the embodiments. Now that embodiments of the present inventive subject matter have been shown and described in detail, various modifications and improvements thereon can become readily apparent to those skilled in the art. Accordingly, the exemplary embodiments of the present inventive subject matter, as set forth above, are intended to be illustrative, not limiting. The spirit and scope of the present inventive subject matter is to be construed broadly.

What is claimed is:

1. A computer-implemented method for assisting users in vehicle maintenance, comprising:
receiving a user input specifying a vehicle's make, model, year, and a maintenance issue;
processing the user input through an artificial intelligence engine;
generating vehicle-specific maintenance advice based on the processed input; and
displaying the advice to the user through a user interface.

2. The method according to claim 1, wherein the maintenance advice includes step-by-step troubleshooting guidance.

3. The method according to claim 1, further comprising the step of linking to an online store for purchasing recommended parts.

4. The method according to claim 1, further incorporating a feature to suggest vehicle upgrades or modifications based on the analysis of repeated issues or queries.

5. The method according to claim 1, where the user input is extended to include non-standard vehicle parameters like engine type or drive train type.

6. The method of claim 1, further comprising dynamically adjusting the verbosity or technicality of the advice based on a detected user expertise level.

7. The method of claim 1, further comprising storing a history of user interactions and generating predictive prompts based on prior inputs.

8. The method of claim 1, wherein the AI engine is trained using datasets derived from one or more of the following: repair manuals, mechanic forums, and parts catalogs.

9. The method of claim 1, further comprising identifying one or more incompatible or counterfeit parts and alerting the user to the identification of the one or more incompatible or counterfeit parts and related data.

10. The method of claim 1, further comprising a gamified feedback mechanism awarding users based on successful task completion.

11. A system for vehicle assistance, comprising:
a user interface configured to receive data inputs related to vehicle specifications and user queries;
an artificial intelligence engine programmed to analyze the data inputs and identify relevant vehicle issues;
a database storing user-specific vehicle data and associated queries; and
a communication module to present solutions and parts recommendations based on the engine's analysis.

12. The system according to claim 11, wherein the artificial intelligence engine updates its responses based on feedback received from users regarding the accuracy of the advice and recommendations.

13. The system according to claim 11, wherein the user interface includes a graphical slider allowing users to specify their skill level, which adjusts the complexity of the information presented.

14. The system according to claim 11, further incorporating a feature to save historical user queries to streamline future interactions.

15. The system according to claim 11, wherein the system is capable of integrating with one or more multiple external databases to enhance the accuracy of parts and services recommendations.

16. The system of claim 11, further comprising an onboard diagnostic port interface for retrieving real-time vehicle telemetry and using it in analysis.

17. The system of claim 11, wherein user interaction data is stored in at least one decentralized ledgers in order to verify repair attempts and repair attempt results.

18. The system of claim 11, further comprising a module for overlaying repair instructions using augmented reality (AR) glasses.

19. The system of claim 11, wherein the artificial intelligence engine further comprises a large language model fine-tuned with mechanical service data.

20. The system of claim 11, further comprising a mechanic network interface enabling live support from certified mechanics based on AI triage.
